(19) United States
(12) Patent Application Publication
(10) Pub. No.: US 2023/0281258 A1
(43) Pub. Date: Sep. 7, 2023

(54) Systems and Methods for Generating Contextual Dynamic Content

(71) Applicant: Google LLC, Mountain View, CA (US)

(72) Inventors: Matthew Michael Serletic, II, Calabasas, CA (US); Dean Albert Serletic, Calabasas, CA (US); Dylan Louis Stevenson, Santa Monica, CA (US); Patrick Cameron Woodward, Sherman Oaks, CA (US); Brett Christopher Harrison, Oak Park, CA (US)

(21) Appl. No.: 18/010,319

(22) PCT Filed: Sep. 23, 2021
(86) PCT No.: PCT/US2021/051754

§ 371 Date: Dec. 14, 2022

Related U.S. Application Data
(60) Provisional application No. 63/082,177, filed on Sep. 23, 2020.

(51) Int. Cl. G06F 16/953; G06T 13/00

(52) U.S. Cl. CPC G06F 16/953; G06T 13/00

(57) ABSTRACT

A computer-implemented method for providing contextual dynamic content to improve user engagement can include obtaining, by a computing system including one or more computing devices, a user query. The computer-implemented method can include identifying, by the computing system, a selected template of a plurality of candidate templates based at least in part on the user query. The computer-implemented method can include obtaining, by the computing system, content data respective to the selected template. The computer-implemented method can include obtaining, by the computing system, animation data based at least in part on the selected template and the content data. The computer-implemented method can include obtaining, by the computing system, dynamic content based at least in part on the animation data. The computer-implemented method can include providing, by the computing system, the dynamic content for display to a user.

This application is based upon and claims the right of priority to U.S. Provisional Application No. 63/082,177, filed on Sep. 23, 2020, the disclosure of which is hereby incorporated by reference herein in its entirety for all purposes.

### FIELD

The present disclosure relates generally to dynamic content. More particularly, the present disclosure relates to systems and methods for generating contextual dynamic content.

### BACKGROUND

Computing devices can include components capable of providing dynamic content, such as image content, video content, and/or accompanying audio content to user(s) of the computing device. For instance, dynamic content can be or can include time-varying visual and/or audio signals that are provided to the user for entertainment and/or information. The dynamic content can be provided, for example, by a display screen and/or audio playback device.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for providing contextual dynamic content to improve user engagement. The computer-implemented method can include obtaining, by a computing system including one or more computing devices, a user query. The computer-implemented method can include identifying, by the computing system, a selected template of a plurality of candidate templates based at least in part on the user query. The computer-implemented method can include obtaining, by the computing system, content data respective to the selected template. The computer-implemented method can include obtaining, by the computing system, animation data based at least in part on the selected template and the content data. The computer-implemented method can include obtaining, by the computing system, dynamic content based at least in part on the animation data. The computer-implemented method can include providing, by the computing system, the dynamic content for display to a user.

Another example aspect of the present disclosure is directed to a computing system configured to provide contextual dynamic content to improve user engagement. The computing system can include one or more processors and one or more memory devices storing computer-readable instructions that, when implemented, cause the one or more processors to perform operations. The operations can include obtaining a user query. The operations can include identifying a selected template of a plurality of candidate templates based at least in part on the user query. The operations can include obtaining content data respective to the selected template. The operations can include obtaining animation data based at least in part on the selected template and the content data. The operations can include obtaining dynamic content based at least in part on the animation data. The operations can include providing the dynamic content for display to a user.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a diagram of an example computing system that performs dynamic content generation according to example embodiments of the present disclosure.

FIG. 2 depicts a diagram of an example computing system that performs dynamic content generation according to example embodiments of the present disclosure.

FIG. 3 depicts a diagram of an example computing system that performs dynamic content generation according to example embodiments of the present disclosure.

FIG. 4 depicts a diagram of an example computing system that performs dynamic content generation according to example embodiments of the present disclosure.

FIG. 5 depicts an example template and example dynamic content produced based at least in part on the example template according to example embodiments of the present disclosure.

FIG. 6 depicts an example template and example dynamic content produced based at least in part on the example template according to example embodiments of the present disclosure.

FIG. 7 depicts an example template and example dynamic content produced based at least in part on the example template according to example embodiments of the present disclosure.

FIG. 8 depicts an example animation transition template and corresponding dynamic content items according to example embodiments of the present disclosure.

FIG. 9 depicts at least a portion of an example user interface that may be presented to a user in response to a user query for dynamic content.

FIG. 10 depicts an example user interface flow for generating and/or sharing dynamic content presented in response to an internet search according to example embodiments of the present disclosure.

FIG. 11 depicts examples of dynamic content that may be provided for stylized text.

FIG. 12 depicts an example user interface flow for generating and/or sharing dynamic content presented in a messaging application according to example embodiments of the present disclosure.

FIG. 13 depicts an example user interface for searching for dynamic content according to example embodiments of the present disclosure.

FIG. 14 depicts example dynamic content including a live tile according to example embodiments of the present disclosure.

FIG. 15 depicts a flow chart diagram of an example method for providing contextual dynamic content to improve user engagement according to example embodiments of the present disclosure.

Reference numerals that are repeated across plural figures are intended to identify the same features in various implementations.

### DETAILED DESCRIPTION

Generally, the present disclosure is directed to systems and methods for generating and/or providing dynamic content. Dynamic content can include static and/or animated images, stickers, etc. that can graphically convey information to a user in a stylized manner. In some cases, the dynamic content may include and/or otherwise be provided with and/or without accompanying audio, such as music, sound effects, etc. The systems and methods described herein can provide contextual dynamic content appropriate for a user's context and/or actions that can increase user engagement and/or enjoyment. As one example, the dynamic content can facilitate sharing of content associated with real-time events (e.g., sporting events), news articles, messages, and/or other online content. As another example, the dynamic content can be shared between users (e.g., in messaging applications) to provide for personalized communication. As another example, the dynamic content can be provided along with music or other audio to improve user enjoyment of the audio. As another example, the dynamic content can be provided as part of an augmented reality experience. The dynamic content can be dynamically generated with regard to a plurality of templates, which can facilitate responsive and intelligent generation of dynamic content.

For instance, systems and methods according to example aspects of the present disclosure can provide fun and useful dynamic content to users, which can engage users and increase their involvement with services providing the dynamic content. Finding personalized content can be challenging. Even with a wide variety of pre-existing content, users may endlessly scroll, tap, and navigate through hundreds if not thousands of content items that still fail to convey the user's message. Systems and methods according to example aspects of the present disclosure, however, can provide for perfectly personalized content for every user query. Even mundane messages like “Good morning, Matt” can become entertaining dynamic images. Furthermore, the dynamic content can be produced without requiring localization to different languages, as long as input characters are supported.

Example aspects of the present disclosure are directed to a computer-implemented method for generating and/or providing contextually-appropriate dynamic content, such as to increase user engagement with a service. In some embodiments, the computer-implemented method can be implemented by a computing system including one or more computing devices. As one example, a computing system can include one or more processors and one or more memory devices storing computer-readable instructions. The one or more processors can implement the computer-readable instructions to cause the one or more processors to perform operations of the computer-implemented method. As one example, the computing system can be or can include a client device, such as a mobile device (e.g., a smartphone, tablet computer, laptop computer, etc.) and/or a server computing system.

For instance, the operations and/or the computer-implemented method can include obtaining (e.g., by a computing system including one or more computing devices) a user query. In some embodiments, the user query can be obtained (e.g., from one or more user interfacing components) by a client computing device. For example, a client computing device can include one or more input components, such as buttons, microphones, keyboards, touch-sensitive screens and/or surfaces, cameras, etc., that are configured to receive user input and/or provide data associated with the user query in response to the user input.

Additionally and/or alternatively, the user query can be obtained by a server computing system. For example, the user query can be transmitted from a client computing device to a server computing system (e.g., by one or more network(s), such as 802.11 network(s), WiFi network(s), the Internet, etc.). The server computing system can receive the user query from the client computing device. In some embodiments, the user query may be compressed, anonymized, and/or otherwise preprocessed prior to being transmitted through the network. For example, the client computing device may transmit a condensed user query, such as a user query that includes at least data necessary for generating dynamic content and includes only a limited to no amount of extraneous data from the user query received at the client computing device.

The user query can be provided directly from a user, such as through a user input. For example, the user may directly input a message (e.g., text data) into a user input field and retrieve dynamic content based on the message. Additionally and/or alternatively, the user query may be provided indirectly from a user's actions. As one example, the user query can be or can include data that is obtained in response to a user input for a secondary function, such as opening an application, navigating to a webpage, performing an internet search, etc. For instance, any suitable user action may prompt generation and/or delivery of dynamic content in accordance with example aspects of the present disclosure.

As one example, the user query can be or can include text data, such as text data including one or more characters (e.g., ASCII characters). For example, the text data can be a string of characters. In some embodiments, the text data can be a message, such as a text message. For example, the message can be transmitted through a text messaging application, social media application, etc. For example, animated fonts and/or graphics can be generated based on the text data.

As another example, the user query can be a search engine query. For instance, in some embodiments, the search engine query can include text data such as at least a portion of a user search, such as an input into a search engine, such as an internet search engine. For example, the user can input the user query into a search engine as a search engine query to retrieve results responsive to the search engine query. As one example, the user may search for information on a (e.g., ongoing) sporting event in an effort to retrieve information associated with the sporting event, such as a current score, timeline of scoring events, current time remaining, etc.

As another example, the user query can include data such as a news article, such as a news article headline. For example, the user query may be provided in response to a user accessing a news feed. The dynamic content may be provided to highlight a subject of the news article. For example, a news article relating to sports may be provided with dynamic content animating the headline with, for example, a bouncing ball, field goal, etc., depending on a type of sport that the article relates to.

As another example, the user query can be or can include audio data. For example, the user query can include a user selecting an audio file for playback. The audio data can be captured by one or more microphones and/or other audio capturing system(s). For example, the user query may include audio data that is converted to text data, such as by a speech-to-text system (e.g., a speech-to-text model). The user query may include one or both of the converted text data and/or the source audio data. Additionally and/or alternatively, the audio data can be or can include music and/or other audio recordings, such as music and/or audio recordings including spoken words (e.g., lyrics). For example, the user can select an audio file (e.g., a song, podcast, etc.) for streaming, playback, etc. and the user query can include an indication of the selected audio file (e.g., a title, artist, identifier, etc.) and/or at least a portion of the audio file itself.

As another example, the user query can be or can include video data. For example, the user query may include video data captured by one or more cameras and/or other video capturing system(s) (e.g., in addition to accompanying audio data). As one example, the video data can be captured as part of an augmented reality (AR) system, such as a system for providing increased user interactivity with a user's surroundings. For example, the user query can include video data from an AR system and the dynamic content can be overlays for the video data.

As another example, the user query can be or can include context data. The context data can define a current state of a computing device (e.g., a user computing device) at which the user query is received. Additionally and/or alternatively, the context data may be indicative of a state of the user. As one example, the context data can be or can include a current time, current weather, current application context (e.g., which application(s) are currently open, selected, running, etc. on the computing device), and/or other suitable context data.

As another example, the user query can be a navigation action that prompts providing dynamic content. As one example, the user query can be a navigation action such as opening up a dynamic content keyboard (e.g., in a messaging application), such as a virtual keyboard. The dynamic content can be provided based on current text in a message when the keyboard is opened. Additionally and/or alternatively, the user may be given the opportunity to generate dynamic content when the dynamic content keyboard is opened. For example, the keyboard may provide the user with dynamic content tailored for a message as the user types, speaks, or otherwise composes the message. As another example, the keyboard may allow the user to input a message for which dynamic content can be generated. As another example, the user query can be a navigation action such as selecting a “share” option or similar option on an information item (e.g., a sporting event scorecard). For example, the user can click on or otherwise select a share option, such as a user interface element tied to a sharing function, that enables the user to provide the dynamic content to contacts of the user, such as by sending the dynamic content as an image or video clip, sharing a hyperlink to the dynamic content, etc. For example, in some embodiments, if a recipient supports displaying the dynamic content, the dynamic content may be provided directly (e.g., as image content). If the recipient does not support displaying the dynamic content and/or if display capability is unknown, the link may be shared instead.

Additionally and/or alternatively, the operations and/or the computer-implemented method can include identifying (e.g., by the computing system) a selected template from a plurality of candidate templates based at least in part on the user query. The template can include instructions for generating dynamic content. In some embodiments, the template can include one or more content items to be populated based at least in part on content data. For example, the template can include instructions for providing one or more content items, such as, for example, static images, animated images, sound effects and/or other audio clips, text items, graphics, color fills, and/or other suitable content items. For example, the template can include location, size (e.g., bounding boxes, scaling, maximum string size or character length, aspect ratio, etc.), font and/or other text style, image style, color(s) (e.g., color arrangements), content type, and/or any other suitable rules, specifications, and/or other information for each content item. The templates can be provided as computer-readable data such that dynamic content can be generated based on the templates and supplemental content data that describes how the template is filled out. As one example, the templates can define and/or otherwise include one or more containers (e.g., as content items) capable of receiving one or more types of content, such as text, emoticons and/or emojis, images (e.g., animated images), etc. As one example, natural language processing can be applied to match a template to a user query. Additionally and/or alternatively, sentiment analysis can allow for appropriate art styles (e.g., “Love” matched to heart-shaped templates, etc.) to be selected.

In some embodiments, identifying the selected template can include determining, (e.g., by the computing system) a theme of the user query and identifying (e.g., by the computing system) the selected template based at least in part on the theme of the user query. For instance, in some embodiments, the theme may be identified based on a nature of the user query. For example, if the user searches for a score of a sporting event, templates appropriate for conveying sporting event data (e.g., scoreboards, scoring events, etc.) may be used to provide dynamic content. As another example, semantic analysis may be performed on context data, text data, etc. to determine an appropriate theme of a user query.

Furthermore, in some embodiments, a plurality of candidate templates can include associated themes that define appropriate contexts for the templates. The themes may be explicitly defined, defined by machine learning (e.g., classification), etc. As one example, a candidate template may include a theme such as “sports” that indicates that the candidate template is related to sporting events, such as appropriate to provide for user queries relating to sporting events. As another example, a candidate template may include and/or otherwise be associated with a theme such as “touchdown” that indicates the template is appropriate for a touchdown scoring event. Thus, to identify the selected template, the computing system can match a theme of the user query to an appropriate template.

As one example, the selected template can define a sporting event template, such as a scoreboard or scorecard template, a scoring event template, etc. For example, a scoreboard template may display information about a current state of the sporting event, such as a current score, remaining time, current interval (e.g., period, quarter, half, set, round, etc.), penalties, possession, etc. The scoreboard template may define fields for graphically presenting such information to a user.

As another example, the selected template can have a theme such as “Words & Phrases” that provide custom-rendered animations of text data in the user query. For example, a user may input a phrase such as “good morning” and retrieve templates that convey words and phrases. As another example, the selected template can have a theme such as “Holidays” that include stylized and/or animated text and/or graphics based on a nearby holiday. As another example, the theme can be related to brand partners, sporting leagues, etc.

As another example, selected templates can be identified by keywords in a user query that are indicative of a particular theme. For example, a phrase such as “Hello” may be associated with a greeting theme, and the presence of that phrase in a user query may select one or more selected templates having a greeting theme. As another example, the user query contains mention of a holiday and templates having a theme related to that holiday may be selected as the selected template(s).

As another example, the selected template can be explicitly defined in the user query (e.g., a URL). For example, a particular choice of template can be determined prior to preparing and/or transmitting the user query (e.g., by a client service with knowledge of the templates). The user query can contain the selected template.

In some embodiments, the candidate templates can include base templates, such as templates that display an animation for a known scenario. Additionally and/or alternatively, the content templates can include parameter templates that pass values into base templates, such as colors, text (e.g., team name), scores, etc. The parameter templates can be generated from parameters of the user query.

In some embodiments, such as when candidate templates are hosted at a remote server, the templates may be marked with an available status indicating that the template is enabled for dynamic content generation.

Additionally and/or alternatively, the operations and/or the computer-implemented method can include obtaining (e.g., by the computing system) content data respective to the selected template. For example, a computing system can be in communication with a data service (e.g., a service at a remote computing system and/or on the computing system) that stores, retrieves, and/or provides content data to the computing system. As one example, the data service can include a feed of content data, such as sporting event data. For example, the sporting event data can include up-to-date information (e.g., game statistics, etc.) about a state of a current, past, and/or future sporting event, such as game location, game time, score, score history, and other suitable data. This information can be retrieved as sporting event data from the data service as necessary (e.g., as required by the selected template and/or continually). In some embodiments, the content data can be or can include text data. For example, in some embodiments, the content data can include text data from the user query. Additionally and/or alternatively, the content data can include text data such as names of stadiums, players, teams, etc. in sporting event data. As another example, in some embodiments, the content data can be or can include one or more lyrics.

Additionally and/or alternatively, the operations and/or the computer-implemented method can include obtaining animation data based at least in part on the selected template and/or the content data. The animation data can be or can include data that is capable of being consumed by an animation player service such that dynamic content can be produced by the animation player service in response to receipt of the animation data. As one example, the animation data can be or can include JSON data, such as one or more JSON files. For example, the JSON data can provide template data and/or content data in a format that can be interpreted by an animation player service. As one example, the JSON data can include one or more fields. The one or more fields may be at least partially specified by the template. Values of the fields can be populated based at least in part on the content data.

Additionally and/or alternatively, the operations and/or the computer-implemented method can include obtaining (e.g., by the computing system) dynamic content based at least in part on the animation data. For example, in some embodiments, the animation data can be provided to an animation player service that is configured to receive the animation data and output dynamic content based on the animation data. For example, the dynamic content can realize animations, effects, fonts, formatting, etc. that is specified in the animation data. The dynamic content can be provided in any suitable format, such as video data (e.g., MP4 data), animated image data (e.g., GIF data, WebP data, SVG data, etc.), static image data (e.g., PNG data), and/or any other suitable format. For instance, in some embodiments, the dynamic content can be or can include an animated image. In some embodiments, the dynamic content can be or can include stylized text. In some embodiments, the dynamic content can be or can include an image overlay. For example, the dynamic content can be a “sticker” that is intended to be overlaid over image and/or video data.

Additionally, according to example aspects of the present disclosure, content items within the dynamic content may be populated based on content data relating to a sporting event. As one example, team names and/or acronyms may be populated based on content data for a particular sporting event such that the dynamic content produced based on the sporting event template includes names and/or acronyms of teams specific to the event. As another example, colors for regions on the scorecard template (e.g., surrounds, team acronyms, etc.) may be populated such that the scorecard colors match the participants. For example, a background of a region displaying a team name or acronym may be colored with a team's primary and/or secondary color(s). As another example, graphics displayed on the scorecard template may be populated based on content data for a sporting event. For example, graphics depicting sports equipment (e.g., uniforms, helmets, balls, rackets, etc.) may be populated based on the type of sporting event. As one example, dynamic content relating to a basketball game may have graphics depicting basketballs, hoops, shot clocks, etc. while dynamic content relating to a baseball game may have graphics depicting baseballs, bats, baseball helmets, baseball gloves, etc. As another example, a graphic (e.g., a stylized image) depicting a stadium, arena, etc. at which the sporting event takes place can be chosen for the dynamic content based on the current sporting event.

Additionally and/or alternatively, the operations and/or the computer-implemented method can include providing (e.g., by the computing system) the dynamic content for display to a user. As one example, such as if the dynamic content is generated at a user computing device including a display device (e.g., a display screen), the computing device may display the dynamic content to a user directly. As another example, such as if the dynamic content is generated at a server computing system that is separate from a user computing device, the computing system can provide the dynamic content to the user computing device, such as by one or more network(s). For instance, in some embodiments, the dynamic content can be hosted at a centralized server, such as a server computing system (e.g., after the dynamic content is generated). For example, the dynamic content can be cached at the server such that one or more users can access the dynamic content. This can be especially beneficial when the dynamic content is common to many users and/or frequently accessed (e.g., for sporting events). For instance, caching the dynamic content can provide reducing latency and compute-cost and aggregating user render-intents and shares.

Providing the dynamic content for display to the user can include providing a hyperlink to the dynamic content. For example, the hyperlink can allow one or more user computing device(s) to view the dynamic content and/or download the dynamic content. Additionally and/or alternatively, in some embodiments, providing the dynamic content for display to the user can include transmitting the dynamic content from the computing system to a user computing device of the user. For example, after the dynamic content is generated at a server, the dynamic content can be transmitted (e.g., as an image file) to the user computing device, such as included as a part of a webpage retrieval request. In some embodiments, the dynamic content can be stored, cached, and/or otherwise retained at a computing system such that the content can be recycled for users making similar and/or identical queries.

In some embodiments, the user query can initiate a data-driven update of the dynamic content. For example, the user query may establish an initial request for dynamic content, and further updates to the dynamic content may be provided without user intervention as new data becomes available. As one example, the user query may be an internet search that initially returns a dynamic content scorecard for a sporting event. The dynamic content scorecard may be populated based on a live feed of sports data. Animations for the dynamic content scorecard (e.g., animations that play in response to scoring events, end of periods, etc.) may be provided as dynamic content as the sports data is updated, such that the user is kept informed of events by the continual dynamic content.

As one example, the user query can be provided as a HTTP request, such as a URL (e.g., a shortened URL). For example, a dynamic content service (e.g., a content engine) can act as an HTTP endpoint to generate dynamic content for given parameters. The parameters can be included as part of the user query, such as appended to a URL as URL parameters. In some embodiments, the parameters can be shortened, encoded, signed, etc. For example, in some embodiments, the URL and/or URL parameters can be generated at a client service and transmitted to the HTTP endpoint. Furthermore, for example, the dynamic content and/or animation data (subsequently used to render dynamic content) can be returned to the client service for display.

In some embodiments, a content management service can manage and filter content (e.g., templates) to facilitate deployment of a variety of templates. For example, the content management service can shuffle which templates are surfaced such that a user is periodically presented with a fresh selection of templates, although the templates may not be made inaccessible. Additionally and/or alternatively, the content management service may provide templates by region. Additionally and/or alternatively, a content management service can provide a time to live for a template. Additionally and/or alternatively, a content management service can handle character limits, such as by providing “stacked” templates that gracefully handle brackets of character counts. Additionally and/or alternatively, a content management service can provide for handling metadata related to the templates (e.g., for natural language processing). Additionally and/or alternatively, a content management service can provide for a language filter to remove vulgar or explicit content where appropriate.

Systems and methods according to example aspects of the present disclosure can provide for a number of technical effects and benefits. As one example, systems and methods according to example aspects of the present disclosure can provide a user with dynamic content to increase user interactivity with a service. For example, a user can be drawn to information presented in the form of dynamic content as opposed to, for example, regularly formatted text, such that the user is more excited to consume information presented in the dynamic content (e.g., sporting information). For example, a user can be entertained by the dynamic content. As another example, the dynamic content can be shared such that a user can encourage other users to view the dynamic content, which can increase user activity with the dynamic content.

With reference now to the Figures, example embodiments of the present disclosure will be discussed in further detail.

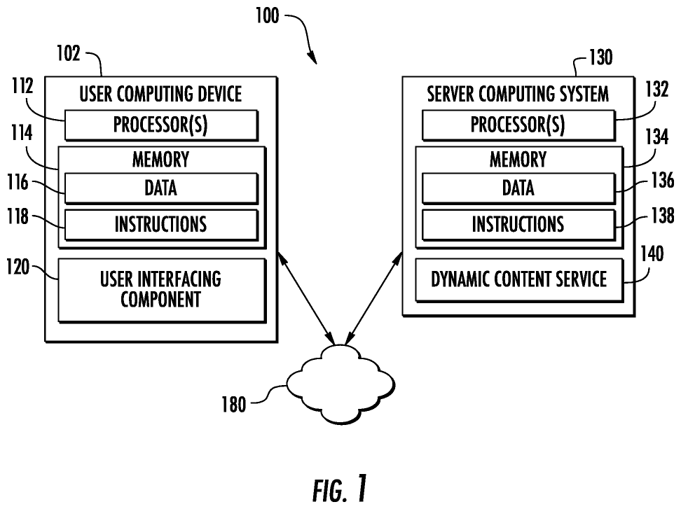

FIG. 1 depicts a block diagram of an example computing system 100 that performs dynamic content generation according to example embodiments of the present disclosure. The system 100 includes a user computing device 102 and a server computing system 130 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

The user computing device 102 can also include one or more user interfacing components 120 that are configured to interface with the user. For instance, the user interfacing components 120 can be configured to receive input from and/or provide information to a user. For example, the user interfacing component 120 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user interfacing components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

The server computing system 130 can include dynamic content service 140. Additionally and/or alternatively, in some embodiments, at least a portion of dynamic content service 140 can be stored at and/or implemented at user computing device 102. Dynamic content service 140 can be configured to provide dynamic content for display at user computing device 102. For instance, dynamic content service 140 can receive a user query from user computing device 102 (e.g., from at least user interfacing component 120), and, in response to receipt of the user query, generate and/or provide dynamic content to user computing device 102.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

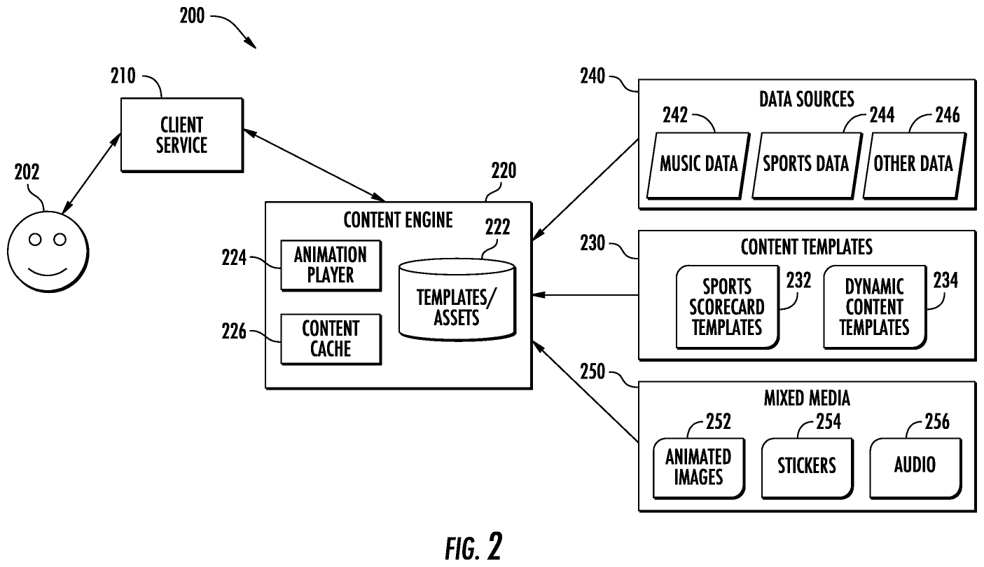

FIG. 2 depicts a diagram of an example computing system 200 that performs dynamic content generation according to example embodiments of the present disclosure. As depicted in FIG. 2, a user 202 can interact with a client service 210. For example, the client service 210 can be implemented at a client computing device (e.g., user computing device 102 of FIG. 1). The client service 210 can be a computer-implemented service (e.g., an instance of a program or application) that provides, in some embodiments among other things, for generating and/or displaying dynamic content to the user. For example, the client service 210 can receive user input that may include and/or may subsequently cause a user query to be provided as a request for dynamic content.

As one example, the client service 210 can be a client-side search engine service. For instance, the client-side search engine service can communicate at least one user search engine query from the client device to a search engine server. Additionally and/or alternatively, the client-side search engine service can retrieve and/or display results responsive to the user search engine query from the search engine server. Thus, the client-side search engine service can provide a user with the capability of quickly and/or conveniently retrieving vast amounts of tailored information from a searchable dataset, such as the Internet.

As another example, the client service 210 can be a messaging service. For instance, the messaging service can send and/or receive messages, such as text messages, multimedia messages, images, etc. from a first computing device and/or a first service to a second computing device and/or a second service. For example, a messaging service associated with a first user (e.g., a first user account) can receive and/or transmit messages to and/or from a messaging service associated with a second user (e.g., a second user account) such that the first user and second user can communicate via the messaging services. The messages may be transmitted by a cellular network, a wireless network (e.g., an 802.11 network) and/or any other suitable forms of communication. In some embodiments, the client service 210 can be or can include a keyboard service, such as a virtual keyboard service. The keyboard service can provide for user input of characters (e.g., ASCII characters, Unicode characters, etc.). Additionally and/or alternatively, according to example aspects of the present disclosure, the keyboard service can provide for user customization, selection, and/or input of dynamic content tailored to a user's message. For example, the dynamic content can be provided as an image, hyperlink, etc. from one user to another via the messaging service such that the dynamic content can convey tone, nontextual content, etc. of a message. This can provide for improved messaging capabilities, as it can allow a user to communicate using content other than text and/or pre-existing emoticons/emojis, images, animations, and/or other pre-existing content.

As another example, the client service 210 can be an augmented reality (AR) service. For example, the augmented reality service can be interposed between a sight and/or sound source (e.g., an audiovisual feed, the environment, etc.) and a user's eyes, ears, and/or other senses such that the augmented reality service provides for information to be overlaid between the user and the sources. For example, an AR service can provide for improved user interactivity with an environment, an audiovisual feed, etc. As one example, the AR service can provide dynamic content that is responsive to a user's surroundings.

As another example, the client service 210 can be a media playback service, such as an audio playback service. For example, the media playback service can provide audiovisual content (e.g., media content, such as songs, etc.) to a user. For example, an audio playback service can provide for a user to listen to songs, podcasts, and other audio recordings. According to example aspects of the present disclosure, dynamic content can be provided along with an audio file (and/or an audiovisual file) to accentuate playback of the audio file. For example, dynamic content including song lyrics, podcast subtitles, etc. can be provided in real-time as a portion of the song, podcast, etc. containing the relevant lyrics is played back. As another example, the dynamic content can be responsive to a tone of the audio file. For example, if a podcast mentions aliens, dynamic content including a graphic of a flying saucer may be provided to the user along with the podcast to accentuate the user's experience while consuming the podcast. As another example, lyrics of a song may be stylistically provided via dynamic content to match a tone of the song.

As another example, the client service 210 can provide audio data and/or sound effects that accompany visual dynamic content. For example, sound effects may be provided as part of an audiovisual file, such as an MP4 file etc. The sound effects may accompany visual gestures or actions in the dynamic content. As one example, a graphic depicting a transition may be accompanied by audio of a slide, whoosh, or similar audio that is appropriate for transitions. As another example, a graphic depicting sports content may be accompanied by crowd noise, etc.

In some embodiments, the client service 210 can include various combinations of any and/or all of the features discussed above. For example, a client service 210 can be common to a variety of distinct and/or related functions.

The client service can be in communication with a content engine service 220. For example, in some embodiments (e.g., as depicted in FIG. 2), at least a portion of the content engine service can be provided at a second computing system that is remote from a first computing system (e.g., a client computing device and/or user computing device) at which client service 210 operates. For example, the content engine service 220 can be provided on a server computing system that is in communication with one or more client devices and/or client services 210 (e.g., corresponding to one or more users 202). As one example, the content engine service 220 can be accessed by first-party and/or third-party clients.

The content engine service 220 can be responsible for generating and/or providing the dynamic content. As one example, the content engine service can receive a user query (e.g., from client service 210). For example, the user query can be transmitted from the client service 210, acting as a request for contextual dynamic content. The content engine service 220 can include instructions for at least selecting a selected template, retrieving content data, obtaining animation data, obtaining dynamic content, and/or providing the dynamic content for display to user 202 (e.g., provided to client service 210 for subsequent display to user 202). In some embodiments, some or all of these instructions can be implemented at separate computing devices (e.g., within a server network).

The content engine service 220 can include a local store 222 of content templates (e.g., candidate templates), content data, and/or mixed media, among other suitable data. The local store 222 can include content that is retrieved from content template service 230, content data service 240, and/or mixed media service 250. For example, frequently used templates and/or assets may be kept at local store 222.

As one example, the templates in local store 222 can be retrieved from and/or kept up-to-date from content template service 230. For instance, content template service 230 can include a repository of templates, such as sports scorecard templates 232, dynamic text templates 234, etc. The content engine service 220 can access templates from content template service 230 and/or locally store or cache templates at local store 222. For instance, in some embodiments, each template can be identified by a unique identifier and/or a theme identifier. For example, in some embodiments, the theme identifier can generally identify the template, and the unique identifier can more particularly identify the template.

As another example, content data in local store 222 can be retrieved from and/or kept up-to-date from content data service 240. For instance, content data service 240 can include a repository of content data, such as context-specific content data, such as, for example, music data 242, sports data 244, and/or other data 246. As one example, the music data can include music lyrics, music themes or tones, music recordings, etc. As another example, the sports data can include a register of past, present, and/or future sporting events, team lists, team rosters, team information such as home stadium, primary and/or secondary color(s) (e.g., as hex values), game statistics, player statistics, scoring timelines, game times, and/or other suitable sports data. The content engine service 220 can access content data from content data service 240 and/or locally store or cache content data at local store 222.

As another example, mixed media in local store 222 can be retrieved from and/or kept up-to-date from mixed media service 250. For instance, mixed media service 250 can include a repository of mixed media, such as GIFs 252, stickers 254, audio 256, and/or other suitable mixed media. According to example aspects of the present disclosure, the mixed media can be treated as content data (e.g., used to populate content items in a content template). As another example, the dynamic content can be overlaid on top of mixed media. The content engine service 220 can access mixed media from mixed media service 250 and/or locally store or cache mixed media at local store 222.

Additionally, the content engine service 220 can include and/or otherwise be in communication with an animation player service 224. The animation player service 224 can be configured to receive animation data (e.g., produced based at least in part on a content template and content data) and provide dynamic content based on the animation data. As one example, the animation player service 224 can be a Lottie animation player service, such as Skottie for the Skia graphics engine. For example, the animation player service 224 can receive animation data, such as JSON animation data, and produce dynamic content, such as a GIF file, MP4 file, WebP file, etc.

Additionally and/or alternatively, the content engine service 220 can include and/or otherwise be in communication with a content cache 226. The content cache 226 can be configured to cache dynamic content (e.g., subsequent to being generated by animation player service 224) and/or intermediate components used to generate the dynamic content. As one example, the dynamic content can be cached at content cache 226 such that one or more users can access the dynamic content. For example, in some embodiments, the dynamic content can be hosted at a centralized server including content cache 226, such as a server computing system (e.g., after the dynamic content is generated). This can be especially beneficial when the dynamic content is common to many users and/or frequently accessed (e.g., for sporting events). The content engine service 220 can additionally be configured to provide the dynamic content to user 202. For example, in some embodiments, a computing system including the content engine service 220 can transmit the dynamic content to a computing device including the client service 210. The computing device can then provide the dynamic content to the user, such as by a display screen. For example, the dynamic content can be transmitted as part of a http download and/or other webpage access. Additionally and/or alternatively, the dynamic content can be hosted at a hosting computing system (e.g., the server computing system that includes the content engine service) and the content engine service can provide a link (e.g., a hyperlink) to the dynamic content at the hosting computing system. As another example, the dynamic content can be embedded in a webpage.

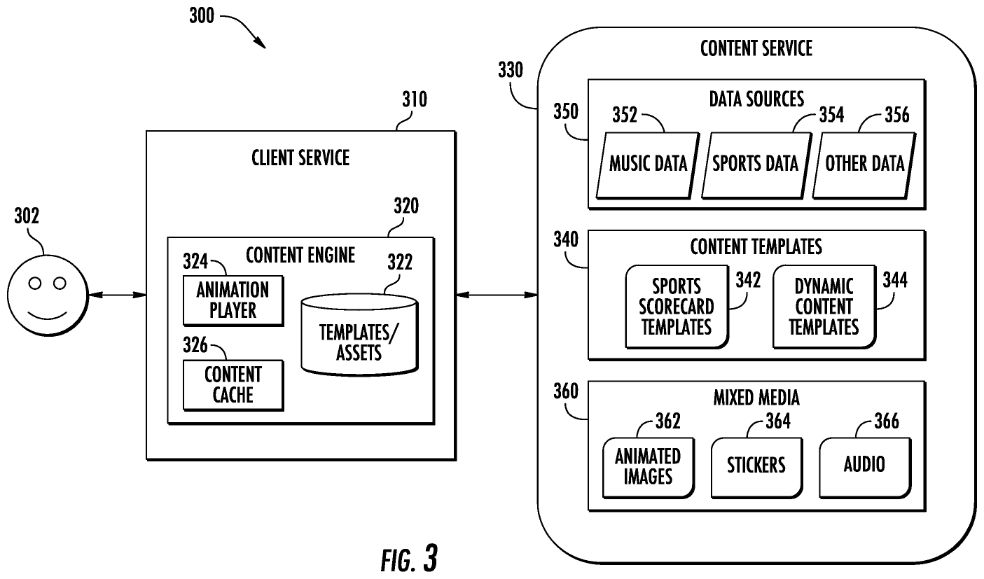

FIG. 3 depicts a diagram of an example computing system 300 that performs dynamic content generation according to example embodiments of the present disclosure. As depicted in FIG. 3, a user 302 can interact with a client service 310. For example, the client service 310 can be implemented at a client computing device (e.g., user computing device 102 of FIG. 1). The client service 310 can be a computer-implemented service (e.g., an instance of a program or application) that provides, in some embodiments among other things, for generating and/or displaying dynamic content to the user. For example, the client service 310 can receive user input that may include and/or may subsequently cause a user query to be provided as a request for dynamic content.

As one example, the client service 310 can be a client-side search engine service. For instance, the client-side search engine service can communicate at least one user search engine query from the client device to a search engine server. Additionally and/or alternatively, the client-side search engine service can retrieve and/or display results responsive to the user search engine query from the search engine server. Thus, the client-side search engine service can provide a user with the capability of quickly and/or conveniently retrieving vast amounts of tailored information from a searchable dataset, such as the Internet.

As another example, the client service 310 can be a messaging service. For instance, the messaging service can send and/or receive messages, such as text messages, multimedia messages, images, etc. from a first computing device and/or a first service to a second computing device and/or a second service. For example, a messaging service associated with a first user (e.g., a first user account) can receive and/or transmit messages to and/or from a messaging service associated with a second user (e.g., a second user account) such that the first user and second user can communicate via the messaging services. The messages may be transmitted by a cellular network, a wireless network (e.g., an 802.11 network) and/or any other suitable forms of communication. In some embodiments, the client service 310 can be or can include a keyboard service, such as a virtual keyboard service. The keyboard service can provide for user input of characters (e.g., ASCII characters, Unicode characters, etc.). Additionally and/or alternatively, according to example aspects of the present disclosure, the keyboard service can provide for user customization, selection, and/or input of dynamic content tailored to a user's message. For example, the dynamic content can be provided as an image, hyperlink, etc. from one user to another via the messaging service such that the dynamic content can convey tone, nontextual content, etc. of a message. This can provide for improved messaging capabilities, as it can allow a user to communicate using content other than text and/or pre-existing emoticons/emojis, images, animations, and/or other pre-existing content.

As another example, the client service 310 can be an augmented reality (AR) service. For example, the augmented reality service can be interposed between a sight and/or sound source (e.g., an audiovisual feed, the environment, etc.) and a user's eyes, ears, and/or other senses such that the augmented reality service provides for information to be overlaid between the user and the sources. For example, an AR service can provide for improved user interactivity with an environment, an audiovisual feed, etc. As one example, the AR service can provide dynamic content that is responsive to a user's surroundings.

As another example, the client service 310 can be a media playback service, such as an audio playback service. For example, the media playback service can provide audiovisual content (e.g., media content, such as songs, etc.) to a user. For example, an audio playback service can provide for a user to listen to songs, podcasts, and other audio recordings. According to example aspects of the present disclosure, dynamic content can be provided along with an audio file (and/or an audiovisual file) to accentuate playback of the audio file. For example, dynamic content including song lyrics, podcast subtitles, etc. can be provided in real-time as a portion of the song, podcast, etc. containing the relevant lyrics is played back. As another example, the dynamic content can be responsive to a tone of the audio file. For example, if a podcast mentions aliens, dynamic content including a graphic of a flying saucer may be provided to the user along with the podcast to accentuate the user's experience while consuming the podcast. As another example, lyrics of a song may be stylistically provided via dynamic content to match a tone of the song.

In some embodiments, the client service 310 can include various combinations of any and/or all of the features discussed above. For example, a client service 310 can be common to a variety of distinct and/or related functions.

The client service can be in communication with a content engine service 320. For example, in some embodiments (e.g., as depicted in FIG. 3), at least a portion of the content engine service can be provided as part of client service 310, such as at a same computing device as client service 310 (e.g., a user computing device).

The content engine service 320 can be responsible for generating and/or providing the dynamic content. As one example, the content engine service can receive a user query (e.g., from client service 310). For example, the user query can be transmitted from the client service 310, acting as a request for contextual dynamic content. The content engine service 320 can include instructions for at least selecting a selected template, retrieving content data, obtaining animation data, obtaining dynamic content, and/or providing the dynamic content for display to user 302 (e.g., provided to client service 310 for subsequent display to user 302).

The content engine service 320 can include a local store 322 of content templates (e.g., candidate templates), content data, and/or mixed media, among other suitable data. In some embodiments, the content engine service 320 (e.g., the local store 322) can be in communication with a central content service 330. For example, central content service 330 can be or can include a centralized repository for content with which dynamic content can be produced. As one example, central content service 330 can include content template service 340, content data service 350, and/or mixed media service 360. For instance, the local store 322 can include content that is retrieved from content template service 340, content data service 350, and/or mixed media service 360. For example, frequently used templates and/or assets may be kept at local store 322.

As one example, the templates in local store 322 can be retrieved from and/or kept up-to-date from content template service 340. For instance, content template service 340 can include a repository of templates, such as sports scorecard templates 342, dynamic text templates 344, etc. The content engine service 320 can access templates from content template service 340 and/or locally store or cache templates at local store 322. For instance, in some embodiments, each template can be identified by a unique identifier and/or a theme identifier. For example, in some embodiments, the theme identifier can generally identify the template, and the unique identifier can more particularly identify the template.

As another example, content data in local store 322 can be retrieved from and/or kept up-to-date from content data service 350. For instance, content data service 350 can include a repository of content data, such as context-specific content data, such as, for example, music data 352, sports data 354, and/or other data 356. As one example, the music data can include music lyrics, music themes or tones, music recordings, etc. As another example, the sports data can include a register of past, present, and/or future sporting events, team lists, team rosters, team information such as home stadium, primary and/or secondary color(s) (e.g., as hex values), game statistics, player statistics, scoring timelines, game times, and/or other suitable sports data. The content engine service 320 can access content data from content data service 350 and/or locally store or cache content data at local store 322.

As another example, mixed media in local store 322 can be retrieved from and/or kept up-to-date from mixed media service 360. For instance, mixed media service 360 can include a repository of mixed media, such as GIFs 362, stickers 364, audio 366, and/or other suitable mixed media. According to example aspects of the present disclosure, the mixed media can be treated as content data (e.g., used to populate content items in a content template). As another example, the dynamic content can be overlaid on top of mixed media. The content engine service 320 can access mixed media from mixed media service 360 and/or locally store or cache mixed media at local store 322.

Additionally, the content engine service 320 can include and/or otherwise be in communication with an animation player service 324. The animation player service 324 can be configured to receive animation data (e.g., produced based at least in part on a content template and content data) and provide dynamic content based on the animation data. As one example, the animation player service 324 can be a Lottie animation player service, such as Skottie for the Skia graphics engine. For example, the animation player service 324 can receive animation data, such as JSON animation data, and produce dynamic content, such as a GIF file, MP4 file, WebP file, etc.

Additionally and/or alternatively, the content engine service 320 can include and/or otherwise be in communication with a content cache 326. The content cache 326 can be configured to cache dynamic content (e.g., subsequent to being generated by animation player service 324) and/or intermediate components used to generate the dynamic content. As one example, the dynamic content can be cached at content cache 326 such that a user can repeatedly access the dynamic content.

The content engine service 320 can additionally be configured to provide the dynamic content to user 302. For example, in some embodiments, the content engine service 320 can transmit the dynamic content to the client service 310. The client service 310 can then provide the dynamic content to the user, such as by a display screen. In this way, the dynamic content can be produced and/or consumed locally. In some embodiments, the client service 310 may (e.g., in response to a user input) then transmit the dynamic content to another service (e.g., a messaging service associated with another user 302).

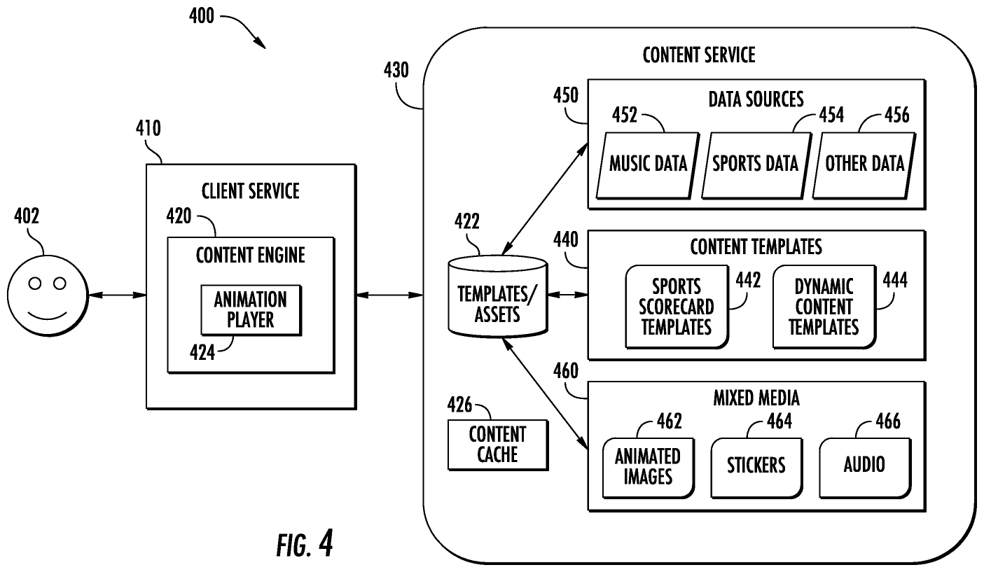

FIG. 4 depicts a diagram of an example computing system 400 that performs dynamic content generation according to example embodiments of the present disclosure. As depicted in FIG. 4, a user 402 can interact with a client service 410. For example, the client service 410 can be implemented at a client computing device (e.g., user computing device 102 of FIG. 1). The client service 410 can be a computer-implemented service (e.g., an instance of a program or application) that provides, in some embodiments among other things, for generating and/or displaying dynamic content to the user. For example, the client service 410 can receive user input that may include and/or may subsequently cause a user query to be provided as a request for dynamic content.

As one example, the client service 410 can be a client-side search engine service. For instance, the client-side search engine service can communicate at least one user search engine query from the client device to a search engine server. Additionally and/or alternatively, the client-side search engine service can retrieve and/or display results responsive to the user search engine query from the search engine server. Thus, the client-side search engine service can provide a user with the capability of quickly and/or conveniently retrieving vast amounts of tailored information from a searchable dataset, such as the Internet.

As another example, the client service 410 can be a messaging service. For instance, the messaging service can send and/or receive messages, such as text messages, multimedia messages, images, etc. from a first computing device and/or a first service to a second computing device and/or a second service. For example, a messaging service associated with a first user (e.g., a first user account) can receive and/or transmit messages to and/or from a messaging service associated with a second user (e.g., a second user account) such that the first user and second user can communicate via the messaging services. The messages may be transmitted by a cellular network, a wireless network (e.g., an 802.11 network) and/or any other suitable forms of communication. In some embodiments, the client service 410 can be or can include a keyboard service, such as a virtual keyboard service. The keyboard service can provide for user input of characters (e.g., ASCII characters, Unicode characters, etc.). Additionally and/or alternatively, according to example aspects of the present disclosure, the keyboard service can provide for user customization, selection, and/or input of dynamic content tailored to a user's message. For example, the dynamic content can be provided as an image, hyperlink, etc. from one user to another via the messaging service such that the dynamic content can convey tone, nontextual content, etc. of a message. This can provide for improved messaging capabilities, as it can allow a user to communicate using content other than text and/or pre-existing emoticons/emojis, images, animations, and/or other pre-existing content.

As another example, the client service 410 can be an augmented reality (AR) service. For example, the augmented reality service can be interposed between a sight and/or sound source (e.g., an audiovisual feed, the environment, etc.) and a user's eyes, ears, and/or other senses such that the augmented reality service provides for information to be overlaid between the user and the sources. For example, an AR service can provide for improved user interactivity with an environment, an audiovisual feed, etc. As one example, the AR service can provide dynamic content that is responsive to a user's surroundings.

As another example, the client service 410 can be a media playback service, such as an audio playback service. For example, the media playback service can provide audiovisual content (e.g., media content, such as songs, etc.) to a user. For example, an audio playback service can provide for a user to listen to songs, podcasts, and other audio recordings. According to example aspects of the present disclosure, dynamic content can be provided along with an audio file (and/or an audiovisual file) to accentuate playback of the audio file. For example, dynamic content including song lyrics, podcast subtitles, etc. can be provided in real-time as a portion of the song, podcast, etc. containing the relevant lyrics is played back. As another example, the dynamic content can be responsive to a tone of the audio file. For example, if a podcast mentions aliens, dynamic content including a graphic of a flying saucer may be provided to the user along with the podcast to accentuate the user's experience while consuming the podcast. As another example, lyrics of a song may be stylistically provided via dynamic content to match a tone of the song.

In some embodiments, the client service 410 can include various combinations of any and/or all of the features discussed above. For example, a client service 410 can be common to a variety of distinct and/or related functions.

The content engine service 420 can include and/or otherwise be in communication with an animation player service 424. The animation player service 424 can be configured to receive animation data (e.g., produced based at least in part on a content template and content data) and provide dynamic content based on the animation data. As one example, the animation player service 424 can be a Lottie animation player service, such as Skottie for the Skia graphics engine. For example, the animation player service 424 can receive animation data, such as JSON animation data, and produce dynamic content, such as a GIF file, MP4 file, WebP file, etc.

The content engine service 420 can be configured to access a server-side content store 422 of content templates (e.g., candidate templates), content data, and/or mixed media, among other suitable data. In some embodiments, the server-side content store 422 can be included in a central content service 430. For example, central content service 430 can be or can include a centralized repository for content with which dynamic content can be produced. As one example, central content service 430 can include content template service 440, content data service 450, and/or mixed media service 460. For instance, the server-side content store 422 can include content that is retrieved from content template service 440, content data service 450, and/or mixed media service 460. For example, content engine service 420 can be configured to request animation data from central content service 430 based on the data in server-side content store 422. The animation data may be communicated from central content service 430 to animation player 424 and played at the content engine service 420.

As one example, the templates in server-side content store 422 can be retrieved from and/or kept up-to-date from content template service 440. For instance, content template service 440 can include a repository of templates, such as sports scorecard templates 442, dynamic text templates 444, etc. The content engine service 420 can access templates from content template service 440 and/or locally store or cache templates at server-side content store 422. For instance, in some embodiments, each template can be identified by a unique identifier and/or a theme identifier. For example, in some embodiments, the theme identifier can generally identify the template, and the unique identifier can more particularly identify the template.

As another example, content data in server-side content store 422 can be retrieved from and/or kept up-to-date from content data service 450. For instance, content data service 450 can include a repository of content data, such as context-specific content data, such as, for example, music data 452, sports data 454, and/or other data 456. As one example, the music data can include music lyrics, music themes or tones, music recordings, etc. As another example, the sports data can include a register of past, present, and/or future sporting events, team lists, team rosters, team information such as home stadium, primary and/or secondary color(s) (e.g., as hex values), game statistics, player statistics, scoring timelines, game times, and/or other suitable sports data. The content engine service 420 can access content data from content data service 450 and/or locally store or cache content data at server-side content store 422.

As another example, mixed media in server-side content store 422 can be retrieved from and/or kept up-to-date from mixed media service 460. For instance, mixed media service 460 can include a repository of mixed media, such as GIFs 462, stickers 464, audio 466, and/or other suitable mixed media. According to example aspects of the present disclosure, the mixed media can be treated as content data (e.g., used to populate content items in a content template). As another example, the dynamic content can be overlaid on top of mixed media. The content engine service 420 can access mixed media from mixed media service 460 and/or store or cache mixed media at server-side content store 422.

Additionally and/or alternatively, the central content service 430 can include and/or otherwise be in communication with a content cache 426. The content cache 426 can be configured to cache dynamic content (e.g., subsequent to being generated by animation player service 424) and/or intermediate components used to generate the dynamic content. As one example, the dynamic content can be cached at content cache 426 such that one or more users can access the dynamic content. For example, in some embodiments, the dynamic content can be hosted at a centralized server including content cache 426, such as a server computing system (e.g., after the dynamic content is generated). This can be especially beneficial when the dynamic content is common to many users and/or frequently accessed (e.g., for sporting events).

The content engine service 420 can additionally be configured to provide the dynamic content to user 402. For example, in some embodiments, the content engine service 420 can transmit the dynamic content to the client service 410. The client service 410 can then provide the dynamic content to the user, such as by a display screen. In this way, the dynamic content can be produced and/or consumed locally. In some embodiments, the client service 410 may (e.g., in response to a user input) then transmit the dynamic content to another service (e.g., a messaging service associated with another user 402).

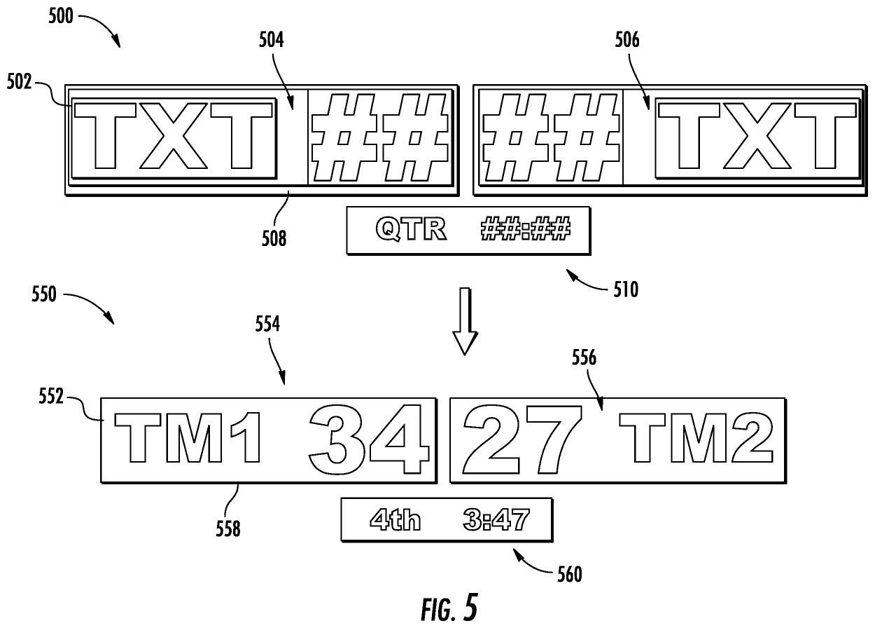

FIG. 5 depicts an example template 500 and example dynamic content 550 produced based at least in part on the example template 500 according to example embodiments of the present disclosure. For instance, template 500 and/or dynamic content 550 depict a sports scorecard. The sports scorecard may be provided in response to a user query intended to retrieve the score (e.g., current and/or past) of a sporting event, such as an American football game. One of ordinary skill in the art will understand that example aspects discussed with respect to the template 500 and/or dynamic content 550 can be applied to any suitable template and/or dynamic content.

FIG. 5 illustrates how an example template 500 can be customized based on content data respective to a particular user query to provide dynamic content 550 that is appropriate for the user query. For example, the dynamic content 550 may be provided in response to a search engine query searching for the score of a sporting event between team 1 and team 2, such as “team 1 v team 2” or “team 1 vs team 2 game” or “football team 1 v team 2” or other suitable related search engine query. As another example, a user may search for a name of a star player, for which the user may intend to see information relating to the star player and/or a team of the star player (e.g., score of a recent sporting event including the star player, performance statistics of the player, etc.). The intent of the user query may be recognized in any suitable manner, such as semantic analysis, natural language processing, etc. As another example, the dynamic content 550 can be a “pre-score” state that gives information on a previous score before an animation is played updating the score based on a scoring event.

The template 500 may include various content items 502-510. For example, content item 502 can be a text field content item. The text field content item 502 can allow for textual content data to be used to populate the text field. Additionally, the text field content item 502 can include various fields, parameters, and/or other specifications that control style, font, color, etc. of the text field. As one example, the font and/or format of the text in content item 502 may be defined per template, and color of the text may be determined based on a team's secondary color, the color of background content item 504, etc. For example, an animation player can consume animation data to produce dynamic text field 552 that includes the text “TM1” (e.g., a team acronym) and conforms to various stylistic specifications of the text field content item 502. Similarly, any suitable text could be utilized in place of “TM1”, such as another team acronym if the template 502 was used for dynamic content responsive to another sporting event.

Additionally, the template 500 can include background content items 504 and 506. For example, background content items 504 and/or 506 may be configured to receive content items such as a color field (e.g., a hexadecimal color), a gradient, an image, etc. As one example, background content item 504 can be populated with a primary color of a team associated with the left side of the scoreboard (e.g., team 1) and background content item 506 can be populated with a primary color of a team associated with the right side of the scoreboard (e.g., team 2). This is illustrated by portions 554 and 556, respectively, of dynamic content 550. Additionally, the template 500 can include a surround content item 508. A similar surround content item may be provided for the right side of the scoreboard. The surround content item 508 can be populated with a secondary color of the team associated with the left side of the scoreboard (e.g., team 1). This is illustrated by surround 558 of dynamic content 550. Thus, FIG. 5 illustrates how a common template 500 can be customized for a particular sporting event by utilizing content data, animation data, and/or an animation player according to example aspects of the present disclosure.

Additionally, the template 500 can include dynamic content items such as clock content item 510. The clock content 510 can display a current game period and/or game time (e.g., current quarter and time remaining in the current quarter). Background and/or text colors of the clock content item 510 may be specified by the template itself, by the content data, and/or in any other suitable manner. As illustrated in dynamic content 550, the clock element 560 can be updated to display the current game period and/or game time. This display can be static, such as display the current game time at a point at which the dynamic content is generated, and/or be dynamic, such that the game time, game period, etc. matches the current game time at each point in time that the dynamic content 550 is displayed.

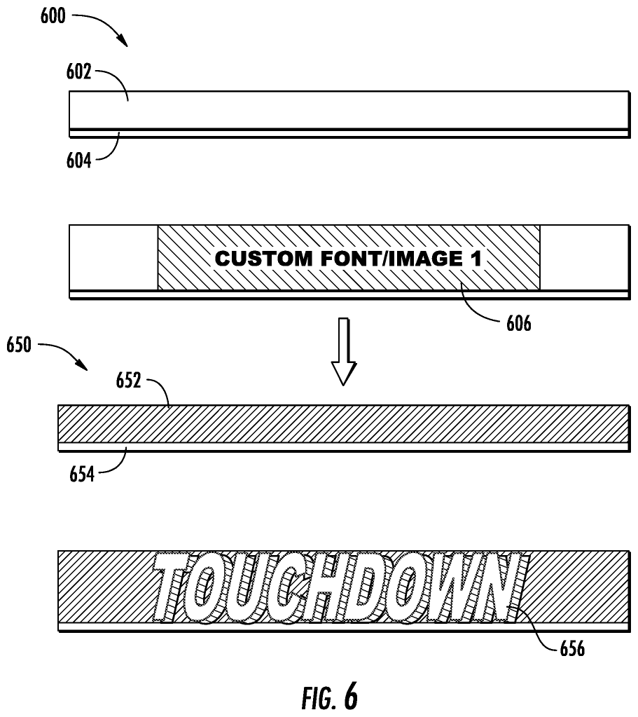

FIG. 6 depicts an example template 600 and example dynamic content 650 produced based at least in part on the example template 600 according to example embodiments of the present disclosure. For instance, template 600 and/or dynamic content 650 depict a sporting event update overlay. The sporting event update overlay may be provided in response to a user query intended to retrieve the score (e.g., current and/or past) of a sporting event, such as an American football game. For example, the overlay may be provided as a data-driven update on top of a scorecard overlay, such as the scorecard depicted in FIG. 5. For example, the dynamic content 650 can be a “pre-score transition” dynamic content that is the first stage of a score update animation. For example, in some embodiments, the graphics may appear from the center and move outward. As another example, the overlay may be provided as an animation on top of a scorecard if a user query is sufficiently close in time to a sporting event update. For example, after a team scores, gets a penalty, or otherwise causes a sporting event update, the overlay may be provided in response to queries for an amount of time after the update. One of ordinary skill in the art will understand that example aspects discussed with respect to the template 600 and/or dynamic content 650 can be applied to any suitable template and/or dynamic content.

The template 600 may include background color content item 602 and/or surround content item 604. For example, the background color content item 602 may be filled with a primary color of a team for which the overlay is provided (e.g., a scoring team, penalized team, etc.). Additionally and/or alternatively, the surround content item 604 may be filled with a secondary color of the team for which the overlay is provided. In this way, the same template can be used for each team. For example, as illustrated by regions 652 and 654 of dynamic content 650, this dynamic content 650 is provided for team 2 of FIG. 5.

The template 600 can additionally include text content item 606. For instance, text content item 606 can be populated with text relating to the sporting event update. For example, the text content item in FIG. 6 is populated with the text “TOUCHDOWN”, as seen by text 656 in dynamic content 650. This text may be provided in response to a team scoring a touchdown. According to example aspects of the present disclosure, the text content item 606 can be populated with any suitable text, such that the same template 600 can be utilized for a variety of sporting event updates. As one example, a team scoring a field goal may prompt dynamic content similar to 650 and based on the same template 600 but including the text “FIELD GOAL” in place of “TOUCHDOWN.” As another example, a team calling a timeout may prompt dynamic content similar to 650 and based on the same template 600 but including the text “TIMEOUT” in place of “TOUCHDOWN.” Similarly, a scoring event in another sport may prompt different text, such as “GOAL” or “HOME RUN” or similar. As another example, a penalty may prompt similar dynamic content but including the text “PENALTY” in place of “TOUCHDOWN.” For instance, in the case of American football, the text may be modified to reflect a pre-game state, a safety, a field goal, a touchdown, a two point conversion, an extra point (e.g., PAT), win state, lose state, and/or other suitable states.

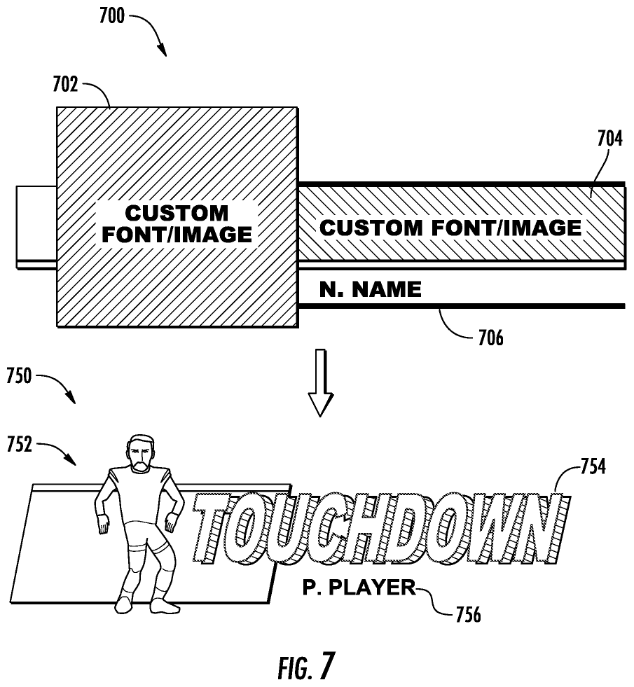

FIG. 7 depicts an example template 700 and example dynamic content 750 produced based at least in part on the example template 700 according to example embodiments of the present disclosure. For example, the dynamic content 750 may be provided in response to a user query requesting to share a game score, such as by sending the dynamic content 750 to a contact, subsequent to a scoring event (e.g., a touchdown). As one example, the dynamic content 750 can be a “celebration” dynamic content that is a second stage of a score update animation. For instance, the graphics may have motion graphics, such as “move-in” animations, to convey energy associated with scoring.

Template 700 can include a content container 702. For instance, content container 702 can be configured to receive any suitable image, font, graphic, etc. In the example depicted in FIG. 7, content container 702 is populated by image 752, which depicts a star player (e.g., a player responsible for the scoring event) in front of a graphic depicting team colors of the star player. For instance, appearance, colors, jersey number, etc. of the star player can be populated based on a template and sports data associated with the sporting event, such as sports data indicating the team, team colors, name of player, player number, etc. As another example, a star player may have an associated animation. For example, the animation performed by a star player may depict a gesture, celebration, etc. commonly associated with the player, sport, etc.

Additionally, template 700 can include a second content container 704. For instance, content container 704 can be configured to receive any suitable image, font, graphic, etc. In the example depicted in FIG. 7, content container 704 is populated by stylized text 754 depicting “TOUCHDOWN.” The stylized text 754 may be an image of text and/or may be text data (e.g., formatted characters).

Additionally, template 700 can include a text field content item 706. For instance, text field content item 706 can be populated with a name of a star player (e.g., a player responsible for the scoring event). As one example, the name of the star player can be conveyed through sports data, such as a timeline of scoring events. The text field content item 706 may define format (e.g., where the player's first name is an initial), font, size, color, etc. For instance, the text field content item 706 can be populated based on content data (e.g., sports data) to produce player name text 756.

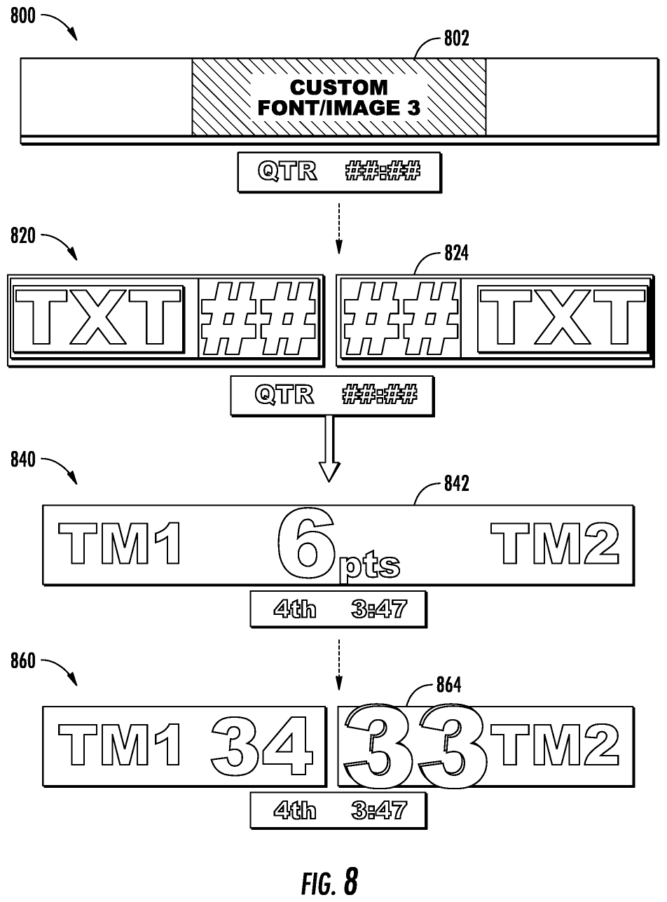

FIG. 8 depicts an example animation transition template and corresponding dynamic content items according to example embodiments of the present disclosure. For instance, templates 800 and 820 can define an animation. For instance, dynamic content produced based on template 800 (e.g., dynamic content 840) can transition to dynamic content based on template 820 (e.g., dynamic content 860). For example, the templates 800 and/or 820 can define animation rules for some or all content items such that the transition is animated. As one example, the dynamic content 840 and/or 860 can be provided in response to a scoring event by team 2. For example, dynamic content 840 may be a “post-celebration transition” dynamic content that is the third stage of a scoring update animation. The dynamic content 840 may then transition to dynamic content 860 (e.g., as a second post-celebration transition) that boldly displays the updated score. For example, the updated score may expand and subsequently shrink to emphasize the update.

For instance, template 800 can include container content item 802. Container content item 802 can be configured to be filled with background colors for a scoring team. Additionally and/or alternatively, container content item 802 can be filled with text (e.g., stylized text) depicting a number of points scored by a scoring team. For example, as depicted by score panel 842, in the event that team 2 scores, the score panel 842 can be filled with team 2's primary color to indicate that team 2 has scored. Additionally, the score panel 842 can briefly overlay the game score to highlight the scoring event.

The dynamic content can then transition to dynamic content 860, which displays a new score. The dynamic content 860 can be based on template 820. For example, template 820 may include a score update content item 824. The score update content item 824 may define font, format, etc. to draw attention to an updated score. For instance, briefly after scoring (e.g., after panel 842 has transitioned), the updated score may transition to the style depicted by score 864. After score 864 has displayed, the animated content may transition back to, for example, the scorecard depicted in FIG. 5. Furthermore, as one example, the animation may include each of the dynamic content items 550-860 of FIGS. 5-8. For example, the animation may begin with dynamic content 550, then transition to dynamic content 650 (e.g., a pre-celebration transition overlay), then transition to dynamic content 750 (e.g., a celebration overlay), then transition to dynamic content 840 (e.g., a post-celebration transition overlay), then transition to dynamic content 860 (e.g., a second post-celebration transition overlay), then finally return to the dynamic content 550, with an updated score. In some embodiments, each of the templates 500, 600, 700, 800, and/or 820 can be included as a package of related templates. For instance, the after-effects templates used for animation (e.g., 600, 700, 800, 820) can be interrelated with the basic template 500.

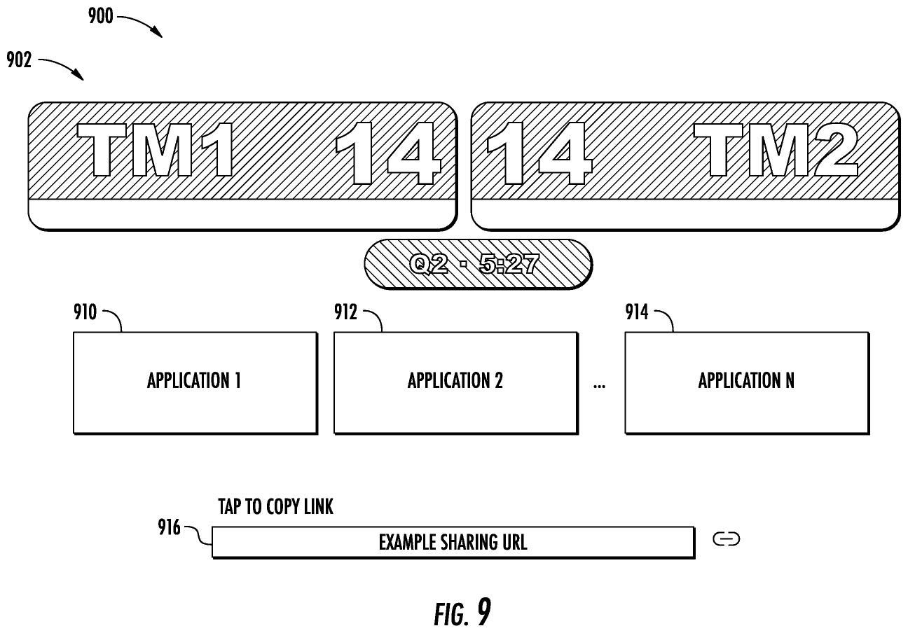

FIG. 9 depicts at least a portion of an example user interface 900 that may be presented to a user in response to a user query for dynamic content. For instance, user interface 900 can display dynamic content 902. The dynamic content 902 may be retrieved from a server (e.g., as embedded content) and/or transmitted (e.g., as an image) to a computing system displaying the user interface 900, as discussed herein. As depicted in FIG. 9, the dynamic content 902 can be a sporting event scorecard displaying information related to the sporting event.

A user may be provided with options in user interface 900 that can enable the user to share the dynamic content 902. For example, the user may be provided with application options 910, 912, 914 that allow the user to select an application to provide the dynamic content 902 to. For example, one of the applications in options 910, 912, 914 may be a social media application. The social media application may allow the user to post the dynamic content to a user's social media account. As another example, one of the applications in options 910, 912, 914 may be a messaging application. The messaging application may allow the user to send the dynamic content to another user of the messaging application. For example, the messaging application may be a text messaging application, email application, etc. Additionally and/or alternatively, the user interface 900 may include link element 916 that provides a link (e.g., a hyperlink, such as a URL, such as a shortened URL) to the dynamic content. The user can interact with the link element 916 to copy and/or otherwise share the link depicted in link element 916.

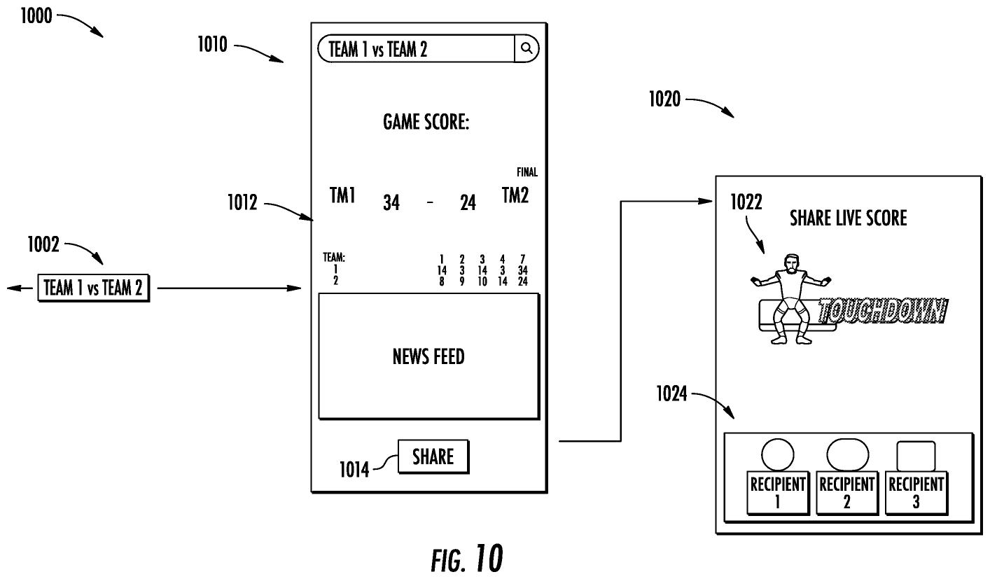

FIG. 10 depicts an example user interface flow 1000 for generating and/or sharing dynamic content presented in response to an internet search according to example embodiments of the present disclosure. For instance, a user can be presented with search bar 1002. The user can input a user query (e.g., a search engine query) into search bar 1002 to retrieve search engine results responsive to the user query. For instance, as depicted in FIG. 10, a user can search for “Team 1 vs Team 2” in the hopes of retrieving information about a sporting event between team 1 and team 2. The search engine can perform semantic and/or other analysis to recognize type of sporting event, instance of game, etc. based on context data such as current date, team name or mascot, etc.

If the search engine recognizes that the user query is directed to a particular sporting event, the user may be provided with search results such as depicted in search results 1010. For example, search results 1010 can include a sporting event overview 1012. The sporting event overview 1012 can include suitable information about the state of the user's queried sporting event, such as, for example, participants, stadium, remaining game time, current score, scoring history, feed of related news articles, etc. For example, sporting event overview 1012 may include a dynamic content scorecard and/or animations such as discussed with reference to FIGS. 5-8. Additionally, the search results 1010 may include share button 1014. A user may interact with (e.g., click, tap, etc.) the share button 1014 if the user wishes to share information about the sporting event with others, such as to social media, contacts, etc.

For instance, the user may be provided with share interface 1020, such as in response to interacting with share button 1014. Share interface 1020 may provide the user with a preview of dynamic content 1022 that will be shared. In some embodiments, the user may be provided with tools to select one or more of several dynamic content items for sharing. For instance, the content engine (e.g., content engine 220 of FIG. 2) may provide several dynamic content items for a single sporting event, such as dynamic content depicting a plurality of different star players responsible for a single scoring event, etc. A user may interact with the dynamic content 1022 (e.g., the preview) such as by swiping, tapping, etc. to select which dynamic content to share. Additionally, the share interface 1020 can display a plurality of sharing options 1024, such as a plurality of contacts, that allow the user to select one or more recipients of the dynamic content 1022. For example, the sharing options 1024 may be provided for a user's contacts, social media platforms, email clients, messaging applications, etc.

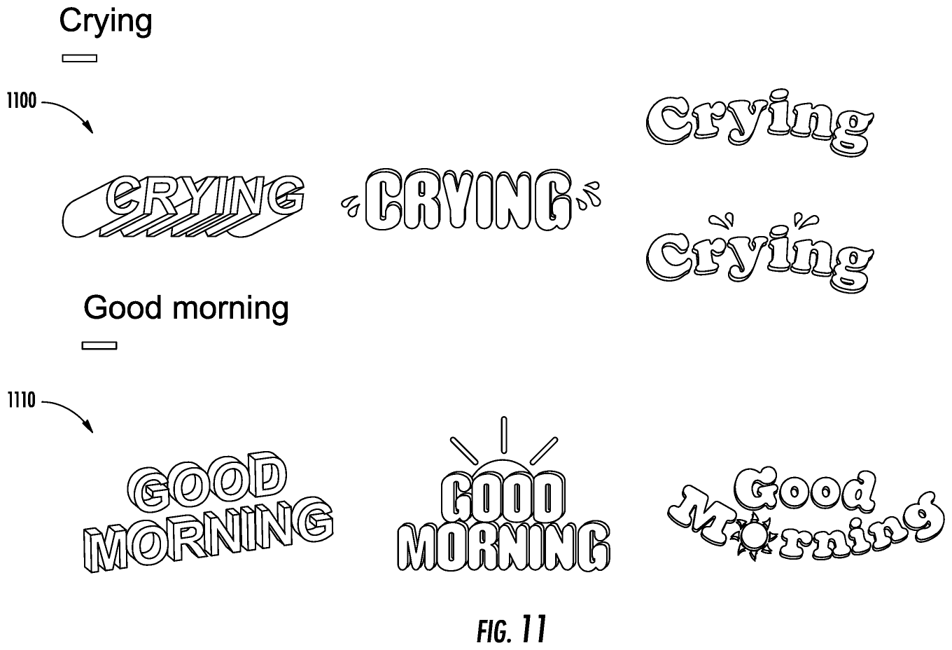

FIG. 11 depicts examples 1100 and 1110 of dynamic content that may be provided for stylized text. For example, the dynamic content in examples 1100 may be provided for a user message containing the text “crying.” The examples 1100 can convey a generally sad tone, color gradient, etc. to match the message text. Similarly, the dynamic content in examples 1110 may be provided for a user message containing the text “good morning.” The dynamic content in examples 1110 may stylistically depict or be associated with mornings.

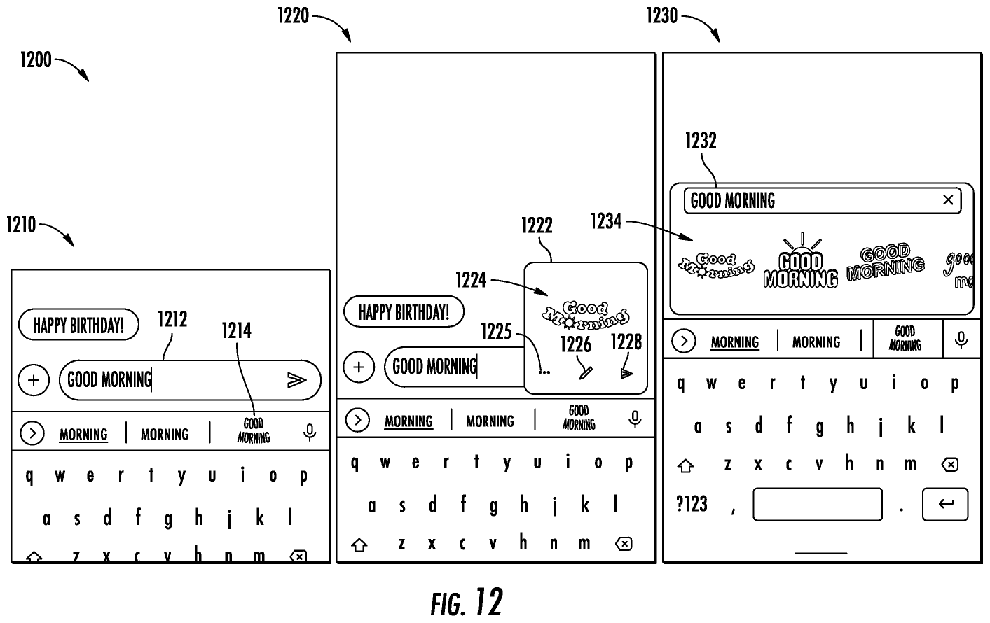

FIG. 12 depicts an example user interface flow 1200 for generating and/or sharing dynamic content presented in a messaging application according to example embodiments of the present disclosure. For example, user interface 1210 can depict a first state of the messaging application. For instance, the user interface 1210 can include a message composition field 1212 that provides for the user to compose a message. As illustrated in FIG. 12, the user has composed the message “Good morning.” The user may choose to send the message as-is, but, according to example aspects of the present disclosure, can choose to personalize the message with dynamic content. For instance, a dynamic content suggestion 1214 can be provided to the user (e.g., automatically) in response to detecting that the user has input a message (e.g., a user query) that is indicative of a user's inclination to use dynamic content. The user can tap the dynamic content suggestion 1214 to send and/or modify the dynamic content.

For instance, the user may tap, hold, or otherwise interact with the dynamic content suggestion 1214 and the user interface 1220 may be presented to the user in response. The user may be provided with dynamic content window 1222. For instance, dynamic content window 1222 can include a preview 1224 of the dynamic content. The user may be provided with extend option 1225 that enables the user to see more options relating to the dynamic content. Additionally and/or alternatively, the user may be provided with edit option 1226 that provides a user with tools and/or other options to edit the dynamic content (e.g., edit text of the dynamic content). Additionally and/or alternatively, the user may be provided with send option 1228 that provides for sending the dynamic content additionally to and/or alternatively to the message in message composition field 1212.

For instance, a user may tap, hold, or otherwise interact with the edit option 1226 and the user interface 1230 may be presented to the user in response. The user interface 1230 can include dynamic text composition field 1232. For example, the dynamic text composition field 1232 may provide for the user to explicitly input text to be used in content items of the dynamic content. Additionally and/or alternatively, the user interface 1230 can include dynamic content previews 1234. The dynamic content previews 1234 can provide a preview of one or more dynamic content items based on the text in dynamic text composition field 1232. In some embodiments, the user may swipe, scroll, or otherwise interact with previews 1234 to see additional dynamic content.

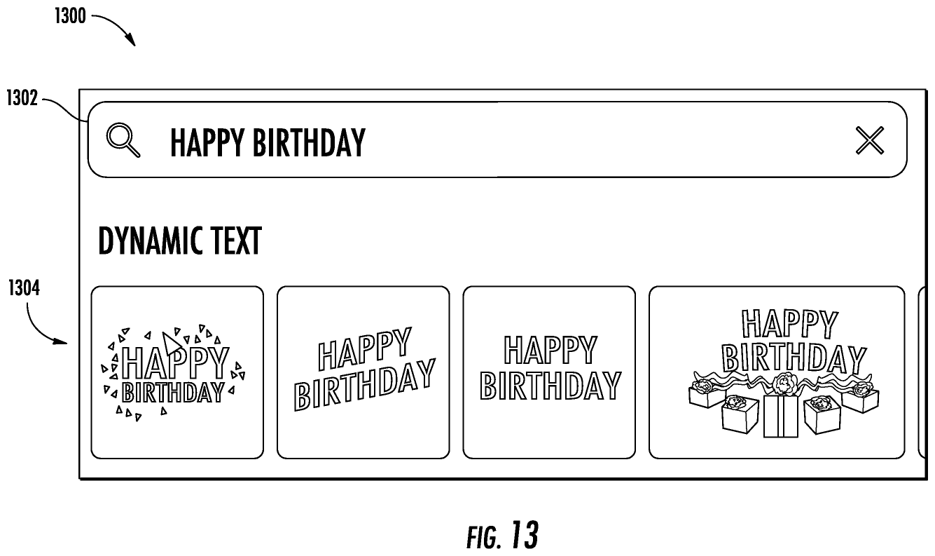

FIG. 13 depicts an example user interface 1300 for searching for dynamic content according to example embodiments of the present disclosure. As one example, user interface 1300 can be provided as part of a search engine, part of a keyboard service, etc. User interface 1300 can include a search field 1302. For example, the search field 1302 can provide for a user to compose a message that includes text to be populated in content items of the dynamic text 1304. For example, the text input by the user into search field 1302 can be provided as part of a user query.

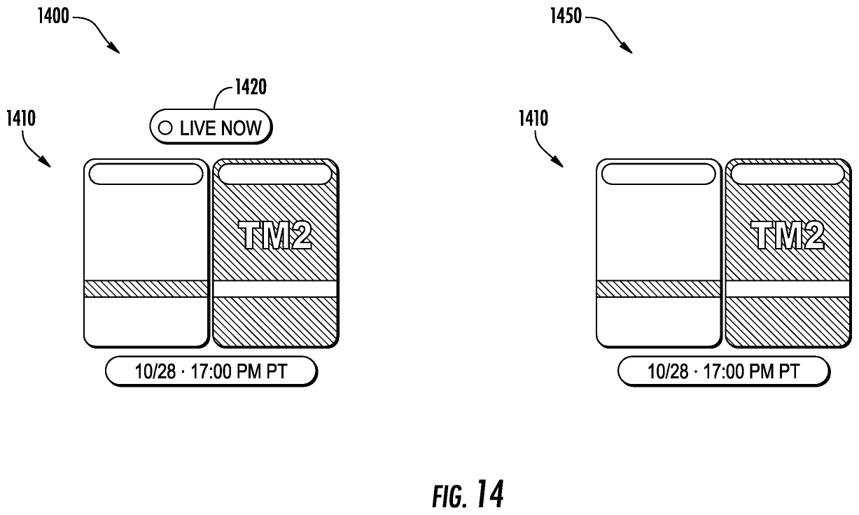

FIG. 14 depicts example dynamic content 1400 including a live tile according to example embodiments of the present disclosure. For instance, dynamic content 1400 can include dynamic content item 1410. As illustrated in FIG. 14, dynamic content item 1410 is a scorecard for a live sporting event. According to example embodiments of the present disclosure, it can be desirable for a user to understand whether a sporting event is live. Thus, dynamic content 1400 can include live tile 1420. Live tile 1420 may be provided to the user to indicate that dynamic content 1410 is live (e.g., may be updated). For instance, the user may be provided with dynamic content 1400 including dynamic content item 1410 and live tile 1420 while the sporting event is live. If the event is not live, however, the user may be provided with dynamic content 1450 which does not include live tile 1420. Thus, live tile 1420 may serve to indicate that the dynamic content item 1410 is live. For example, the dynamic content 1450 may include a final (e.g., locked) state of dynamic content item 1410.

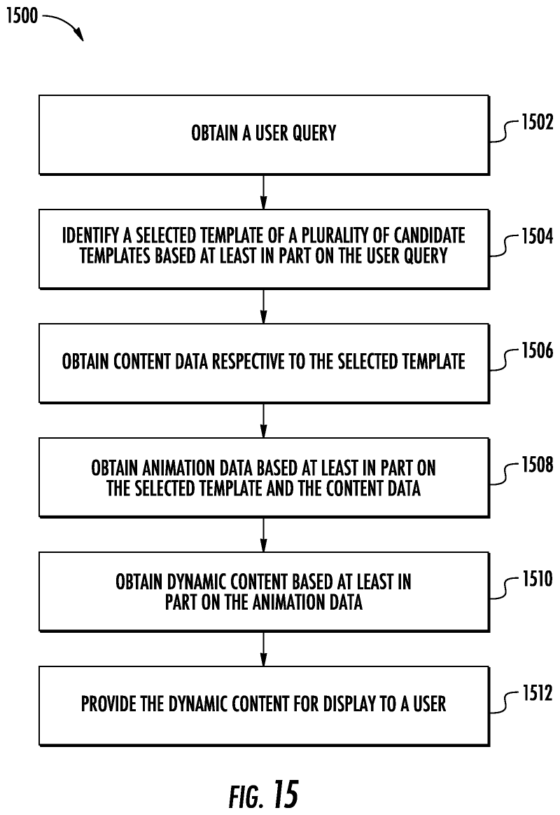

FIG. 15 depicts a flow chart diagram of an example method 1500 for providing contextual dynamic content to improve user engagement according to example embodiments of the present disclosure. Although FIG. 15 depicts steps performed in a particular order for purposes of illustration and discussion, the methods of the present disclosure are not limited to the particularly illustrated order or arrangement. The various steps of the method 1500 can be omitted, rearranged, combined, and/or adapted in various ways without deviating from the scope of the present disclosure.

For instance, the computer-implemented method 1500 can include, at 1502, obtaining (e.g., by a computing system including one or more computing devices) a user query. In some embodiments, the user query can be obtained (e.g., from one or more user interfacing components) by a client computing device. For example, a client computing device can include one or more input components, such as buttons, microphones, keyboards, touch-sensitive screens and/or surfaces, cameras, etc., that are configured to receive user input and/or provide data associated with the user query in response to the user input.

Additionally and/or alternatively, the user query can be obtained by a server computing system. For example, the user query can be transmitted from a client computing device to a server computing system (e.g., by one or more network(s), such as 902.11 network(s), WiFi network(s), the Internet, etc.). The server computing system can receive the user query from the client computing device. In some embodiments, the user query may be compressed, anonymized, and/or otherwise preprocessed prior to being transmitted through the network. For example, the client computing device may transmit a condensed user query, such as a user query that includes at least data necessary for generating dynamic content and includes only a limited to no amount of extraneous data from the user query received at the client computing device.

The user query can be provided directly from a user, such as through a user input. For example, the user may directly input a message (e.g., text data) into a user input field and retrieve dynamic content based on the message. Additionally and/or alternatively, the user query may be provided indirectly from a user's actions. As one example, the user query can be or can include data that is obtained in response to a user input for a secondary function, such as opening an application, navigating to a webpage, performing an internet search, etc. For instance, any suitable user action may prompt generation and/or delivery of dynamic content in accordance with example aspects of the present disclosure.

As one example, the user query can be or can include text data, such as text data including one or more characters (e.g., ASCII characters). For example, the text data can be a string of characters. In some embodiments, the text data can be a message, such as a text message. For example, the message can be transmitted through a text messaging application, social media application, etc. As another example, the user query can be a search engine query. For instance, in some embodiments, the search engine query can include text data such as at least a portion of a user search, such as an input into a search engine, such as an internet search engine. For example, the user can input the user query into a search engine as a search engine query to retrieve results responsive to the search engine query. As one example, the user may search for information on a (e.g., ongoing) sporting event in an effort to retrieve information associated with the sporting event, such as a current score, timeline of scoring events, current time remaining, etc.

As another example, the user query can be or can include audio data. For example, the user query can include a user selecting an audio file for playback. The audio data can be captured by one or more microphones and/or other audio capturing system(s). For example, the user query may include audio data that is converted to text data, such as by a speech-to-text system (e.g., a speech-to-text model). The user query may include one or both of the converted text data and/or the source audio data. Additionally and/or alternatively, the audio data can be or can include music and/or other audio recordings, such as music and/or audio recordings including spoken words (e.g., lyrics). For example, the user can select an audio file (e.g., a song, podcast, etc.) for streaming, playback, etc. and the user query can include an indication of the selected audio file (e.g., a title, artist, identifier, etc.) and/or at least a portion of the audio file itself.

As another example, the user query can be or can include video data. For example, the user query may include video data captured by one or more cameras and/or other video capturing system(s) (e.g., in addition to accompanying audio data). As one example, the video data can be captured as part of an augmented reality (AR) system, such as a system for providing increased user interactivity with a user's surroundings. For example, the user query can include video data from an AR system and the dynamic content can be overlays for the video data.

As another example, the user query can be or can include context data. The context data can define a current state of a computing device (e.g., a user computing device) at which the user query is received. As one example, the context data can be or can include a current time, current application context (e.g., which application(s) are currently open, selected, running, etc. on the computing device), and/or other suitable context data.

As another example, the user query can be a navigation action that prompts providing dynamic content. As one example, the user query can be a navigation action such as opening up a dynamic content keyboard (e.g., in a messaging application), such as a virtual keyboard. The dynamic content can be provided based on current text in a message when the keyboard is opened. Additionally and/or alternatively, the user may be given the opportunity to generate dynamic content when the dynamic content keyboard is opened. For example, the keyboard may provide the user with dynamic content tailored for a message as the user types, speaks, or otherwise composes the message. As another example, the keyboard may allow the user to input a message for which dynamic content can be generated. As another example, the user query can be a navigation action such as selecting a “share” option or similar option on an information item (e.g., a sporting event scorecard). For example, the user can click on or otherwise select a share option, such as a user interface element tied to a sharing function, that enables the user to provide the dynamic content to contacts of the user, such as by sending the dynamic content as an image or video clip, sharing a hyperlink to the dynamic content, etc.

Additionally and/or alternatively, the computer-implemented method 1500 can include, at 1504, identifying (e.g., by the computing system) a selected template from a plurality of candidate templates based at least in part on the user query. The template can include instructions for generating dynamic content. In some embodiments, the template can include one or more content items to be populated based at least in part on content data. For example, the template can include instructions for providing one or more content items, such as, for example, static images, animated images, sound effects and/or other audio clips, text items, graphics, color fills, and/or other suitable content items. For example, the template can include location, size (e.g., bounding boxes, scaling, maximum string size, aspect ratio, etc.) font and/or other text style, image style, color(s) (e.g., color arrangements), content type, and/or any other suitable rules, specifications, and/or other information for each content item. The templates can be provided as computer-readable data such that dynamic content can be generated based on the templates and supplemental content data that describes how the template is filled out. As one example, the templates can define and/or otherwise include one or more containers (e.g., as content items) capable of receiving one or more types of content, such as text, emoticons and/or emojis, images (e.g., animated images), etc.

In some embodiments, identifying the selected template can include determining, (e.g., by the computing system) a theme of the user query and identifying (e.g., by the computing system) the selected template based at least in part on the theme of the user query. For instance, in some embodiments, the theme may be identified based on a nature of the user query. For example, if the user searches for a score of a sporting event, templates appropriate for conveying sporting event data (e.g., scoreboards, scoring events, etc.) may be used to provide dynamic content. As another example, semantic analysis may be performed on context data, text data, etc. to determine an appropriate theme of a user query.

Furthermore, in some embodiments, a plurality of candidate templates can include associated themes that define appropriate contexts for the templates. The themes may be explicitly defined, defined by machine learning (e.g., classification), etc. As one example, a candidate template may include a theme such as “sports” that indicates that the candidate template is related to sporting events, such as appropriate to provide for user queries relating to sporting events. As another example, a candidate template may include and/or otherwise be associated with a theme such as “touchdown” that indicates the template is appropriate for a touchdown scoring event. Thus, to identify the selected template, the computing system can match a theme of the user query to an appropriate template.

As one example, the selected template can define a sporting event template, such as a scoreboard or scorecard template, a scoring event template, etc. For example, a scoreboard template may display information about a current state of the sporting event, such as a current score, remaining time, current interval (e.g., period, quarter, half, set, round, etc.), penalties, possession, etc. The scoreboard template may define fields for graphically presenting such information to a user.

Additionally and/or alternatively, the computer-implemented method 1500 can include, at 1506, obtaining (e.g., by the computing system) content data respective to the selected template. For example, a computing system can be in communication with a data service (e.g., a service at a remote computing system and/or on the computing system) that stores, retrieves, and/or provides content data to the computing system. As one example, the data service can include a feed of content data, such as sporting event data. For example, the sporting event data can include up-to-date information (e.g., game statistics, etc.) about a state of a current, past, and/or future sporting event, such as game location, game time, score, score history, and other suitable data. This information can be retrieved as sporting event data from the data service as necessary (e.g., as required by the selected template and/or continually). In some embodiments, the content data can be or can include text data. For example, in some embodiments, the content data can include text data from the user query. Additionally and/or alternatively, the content data can include text data such as names of stadiums, players, teams, etc. in sporting event data. As another example, in some embodiments, the content data can be or can include one or more lyrics.

Additionally and/or alternatively, the computer-implemented method 1500 can include, at 1508, obtaining animation data based at least in part on the selected template and/or the content data. The animation data can be or can include data that is capable of being consumed by an animation player service such that dynamic content can be produced by the animation player service in response to receipt of the animation data. As one example, the animation data can be or can include JSON data, such as one or more JSON files. For example, the JSON data can provide template data and/or content data in a format that can be interpreted by an animation player service. As one example, the JSON data can include one or more fields. The one or more fields may be at least partially specified by the template. Values of the fields can be populated based at least in part on the content data.

Additionally and/or alternatively, the computer-implemented method 1500 can include, at 1510, obtaining (e.g., by the computing system) dynamic content based at least in part on the animation data. For example, in some embodiments, the animation data can be provided to an animation player service that is configured to receive the animation data and output dynamic content based on the animation data. For example, the dynamic content can realize animations, effects, fonts, formatting, etc. that is specified in the animation data. The dynamic content can be provided in any suitable format, such as video data (e.g., MP4 data), animated image data (e.g., GIF data, WebP data, SVG data, etc.), static image data (e.g., PNG data), and/or any other suitable format. For instance, in some embodiments, the dynamic content can be or can include an animated image. In some embodiments, the dynamic content can be or can include stylized text. In some embodiments, the dynamic content can be or can include an image overlay. For example, the dynamic content can be a “sticker” that is intended to be overlaid over image and/or video data.

Additionally, according to example aspects of the present disclosure, content items within the dynamic content may be populated based on content data relating to a sporting event. As one example, team names and/or acronyms may be populated based on content data for a particular sporting event such that the dynamic content produced based on the sporting event template includes names and/or acronyms of teams specific to the event. As another example, colors for regions on the scorecard template (e.g., surrounds, team acronyms, etc.) may be populated such that the scorecard colors match the participants. For example, a background of a region displaying a team name or acronym may be colored with a team's primary and/or secondary color(s). As another example, graphics displayed on the scorecard template may be populated based on content data for a sporting event. For example, graphics depicting sports equipment (e.g., uniforms, helmets, balls, rackets, etc.) may be populated based on the type of sporting event. As one example, dynamic content relating to a basketball game may have graphics depicting basketballs, hoops, shot clocks, etc. while dynamic content relating to a baseball game may have graphics depicting baseballs, bats, baseball helmets, baseball gloves, etc. As another example, a graphic (e.g., a stylized image) depicting a stadium, arena, etc. at which the sporting event takes place can be chosen for the dynamic content based on the current sporting event. As another example, player statistics (e.g., season statistics, per-game statistics, etc.) can be provided along with a graphic depicting the player.

Additionally and/or alternatively, the computer-implemented method 1500 can include, at 1512, providing (e.g., by the computing system) the dynamic content for display to a user. As one example, such as if the dynamic content is generated at a user computing device including a display device (e.g., a display screen), the computing device may display the dynamic content to a user directly. As another example, such as if the dynamic content is generated at a server computing system that is separate from a user computing device, the computing system can provide the dynamic content to the user computing device, such as by one or more network(s). For instance, in some embodiments, the dynamic content can be hosted at a centralized server, such as a server computing system (e.g., after the dynamic content is generated). For example, the dynamic content can be cached at the server such that one or more users can access the dynamic content. This can be especially beneficial when the dynamic content is common to many users and/or frequently accessed (e.g., for sporting events).

Providing the dynamic content for display to the user can include providing a hyperlink to the dynamic content. For example, the hyperlink can allow one or more user computing device(s) to view the dynamic content and/or download the dynamic content. Additionally and/or alternatively, in some embodiments, providing the dynamic content for display to the user can include transmitting the dynamic content from the computing system to a user computing device of the user. For example, after the dynamic content is generated at a server, the dynamic content can be transmitted (e.g., as an image file) to the user computing device, such as included as a part of a webpage retrieval request.

In some embodiments, the user query can initiate a data-driven update of the dynamic content. For example, the user query may establish an initial request for dynamic content, and further updates to the dynamic content may be provided without user intervention as new data becomes available. As one example, the user query may be an internet search that initially returns a dynamic content scorecard for a sporting event. The dynamic content scorecard may be populated based on a live feed of sports data. Animations for the dynamic content scorecard (e.g., animations that play in response to scoring events, end of periods, etc.) may be provided as dynamic content as the sports data is updated, such that the user is kept informed of events by the continual dynamic content.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for providing contextual dynamic content to improve user engagement, the method comprising:
obtaining, by a computing system comprising one or more computing devices, a user query;
identifying, by the computing system, a selected template of a plurality of candidate templates based at least in part on the user query;
obtaining, by the computing system, content data respective to the selected template;
obtaining, by the computing system, animation data based at least in part on the selected template and the content data;
obtaining, by the computing system, dynamic content based at least in part on the animation data; and
providing, by the computing system, the dynamic content for display to a user.

2. The computer-implemented method of claim 1, wherein the user query comprises text data.

3. The computer-implemented method of claim 1, wherein the user query comprises a search engine query.

4. The computer-implemented method of claim 1, wherein the user query comprises audio data.

5. The computer-implemented method of claim 1, wherein the user query comprises video data.

6. The computer-implemented method of claim 1, wherein the content data comprises sporting event data.

7. The computer-implemented method of claim 1, wherein the content data comprises text data.

8. The computer-implemented method of claim 1, wherein the content data comprises one or more lyrics.

9. The computer-implemented method of claim 1, wherein the selected template comprises one or more content items to be populated based at least in part on the content data.

10. The computer-implemented method of claim 1, wherein identifying the selected template comprises:
determining, by the computing system, a theme of the user query; and
identifying, by the computing system, the selected template based at least in part on the theme of the user query.

11. The computer-implemented method of claim 1, wherein the animation data comprises one or more JSON files.

12. The computer-implemented method of claim 1, wherein the dynamic content comprises an animated image.

13. The computer-implemented method of claim 1, wherein the dynamic content comprises an image overlay.

14. The computer-implemented method of claim 1, wherein the dynamic content comprises a sporting event scorecard.

15. The computer-implemented method of claim 1, wherein the dynamic content comprises stylized text.

16. The computer-implemented method of claim 1, wherein the dynamic content is hosted at a centralized server and wherein providing the dynamic content for display to the user comprises providing a hyperlink to the dynamic content.

17. The computer-implemented method of claim 1, wherein providing the dynamic content for display to the user comprises transmitting the dynamic content from the computing system to a user computing device of the user.

18. A computing system configured to provide contextual dynamic content to improve user engagement, the computing system comprising:
one or more processors; and
one or more memory devices storing computer-readable instructions that, when implemented, cause the one or more processors to perform operations, the operations comprising:
obtaining a user query;
identifying a selected template of a plurality of candidate templates based at least in part on the user query;
obtaining content data respective to the selected template;
obtaining animation data based at least in part on the selected template and the content data;
obtaining dynamic content based at least in part on the animation data; and
providing the dynamic content for display to a user.

19. The computing system of claim 18, wherein the computing system comprises a server computing system, wherein the dynamic content is hosted at the server computing system, and wherein providing the dynamic content for display to the user comprises providing a hyperlink to the dynamic content.

20. The computing system of claim 18, wherein providing the dynamic content for display to the user comprises transmitting the dynamic content from the computing system to a user computing device of the user.
